(19) United States
(12) Patent Application Publication
(10) Pub. No.: US 2002/0016818 A1
(43) Pub. Date: Feb. 7, 2002

(54) System and methodology for optimizing delivery of email attachments for disparate devices

(76) Inventors: Shekhar Kirani, Capitola, CA (US); Mark Whittington, Santa Cruz, CA (US)

Correspondence Address: JOHN A. SMART, 708 BLOSSOM HILL RD., #201, LOS GATOS, CA, 95032, US

(21) Appl. No.: 09/900,384

(22) Filed: Jul. 6, 2001

Related U.S. Application Data
(63) Continuation-in-part of application No. 09/588,875, filed on Jun. 6, 2000.
(60) Provisional application No. 60/203,507, filed on May 11, 2000.

(51) Int. Cl. G06F 15/16

(52) U.S. Cl. 709/203; 709/217

(57) ABSTRACT

An e-mail system that re-packages message attachments optimized for delivery to wireless handheld devices is described. The preferred embodiment provides an optimization of the e-mail deliveries to allow for the recipients to receive e-mail attachments at a time and in a size/format as desired. The preferred embodiment compares the size of attached images to the capabilities of the type of the recipient client device, and preempts delivery of the original format of those attachments if they are determined to be burdensome or overwhelming. In cases wherein these attachments would strain the capabilities of the recipient devices' wireless bandwidth and/or display features, the original attachments are removed from the messages and do not accompany the e-mail delivery. Any detached attachment is saved in a network media-sharing repository, and can be subsequently accessed via a link (e.g., URL) referencing that storage address. Recipients can specify their wireless handheld device types, and opt to receive transformations of this type of attachment as a default substitute in subsequent e-mail deliveries. In cases wherein the recipient has previously used multiple types of client devices when receiving messages from the system, the present invention applies a transformation on the current attachment that corresponds to the least capable in the set of those multiple devices. Recipients may also elect to receive the URL for the network storage address of copies of either the original and/or transformed attachments.

### RELATED APPLICATIONS

The present application is related to and claims the benefit of priority of the following commonly-owned non-provisional application(s): application Ser. No. 09/588,875 (Docket No. LS/0003.01), filed Jun. 6, 2000, entitled “System and Methodology Providing Access to Photographic Images and Attributes for Multiple Disparate Client Devices”, of which the present application is a continuation-in-part application thereof. The present application is related to the following commonly-owned application(s): application Ser. No. 09/814,159 (Docket No. LS/0011.00), filed Mar. 20, 2001, entitled “Media Asset Management System”. The disclosures of each of the foregoing applications are hereby incorporated by reference in their entirety, including any appendices or attachments thereof, for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

The present invention relates to the field of media processing and, more particularly, to system and methodology for transferring and displaying multimedia data on various types of devices, particularly those with wireless connectivity.

2. Description of the Background Art

E-mail attachments preceded wireless network handheld devices and other portable devices. E-mail attachments can of course be used to transmit a variety of different objects, including documents, images, audio, video, or other content (referred to herein collectively as “multimedia”). When used to transmit digital photographs, audio files, or video clips, multimedia e-mail attachments tend to be rather large. These attachments were intended to be received by, and viewed from, relatively powerful desktop computers that are outfitted with an impressive graphical display monitor, good speakers, a good-sized hard disk, and a network bandwidth up to 56K (or 386K for DSL). These features are also standardized across personal computers, or PCs, with respect to size, performance, and utility. In a PC-centric network community, e-mail recipients can universally download and view large multimedia files, in the form of e-mail attachments, with relative ease. Generally, the typical sender of e-mail bearing a multimedia attachment is sending from a PC desktop-type device, and is usually expecting the recipient to engage in their correspondence from a like device.

Due in part to their portability, wireless handheld devices are an increasingly popular alternative to desktop computers. However, in regards to handling large multimedia e-mail attachments, these devices are problematic. For example, the typical viewing screen sizes employed, which are integral to the handiness and utility of a wireless device, are too small for ergonomically displaying rich-content objects, such as digital images. Moreover, the input capability of these devices is often too limited for satisfactory interactive navigation with media content.

Problems also exist with wireless transmission itself. The limiting data transfer rate for wireless devices today is about 9,600 bits per second (baud). Downloading a large file, such as a multimedia e-mail attachment, can consume over an hour (or more) at a transfer rate of 9600 baud. Compounding this transfer problem is the underlying wireless protocol itself. This protocol, which supports the transfer of information across a cellular network, is relatively unreliable. As a result, a wireless connection will often be dropped before a large attachment can be successfully downloaded. This problem is exacerbated when a recipient is mobile, as a given connection will often be dropped due to interference (e.g., obstruction from mountains) or traveling from one service area to another. As a result, a wireless connection is frequently lost during a long download time.

The target devices themselves also pose a problem. The typical device (e.g., handheld computing device) usually employs a relatively small memory, which severely restricts the device's capability of receiving, storing, and/or processing a large e-mail (downloaded) attachment. As a result of this limitation, recipient users will often elect not to download attachments, knowing well that their devices do not have sufficient memory. At the same time, however, each recipient would minimally like to receive at least the body text of the e-mail message, as this is usually quite small, and, therefore, manageable for a small device, such as a portable handheld wireless device.

Attempts to address these problems have focused on improving transport reliability. The basic approach is to employ a communication protocol that enables a given transfer to resume where it left off following a communications failure. Both Zmodem and Ymodem communication protocols supported such an approach. If a connection is prematurely lost, the client or recipient saves the state, and then re-establishes communication with the host (e.g., server) to resume transmission of data, continuing from where the previous transfer left off.

Digital cellular networks currently use Cellular Digital Packet Data (CDPD), a data transmission technology developed for use on cellular phone frequencies. Although it may provide up to double the throughput of analog cellular networks, CDPD is not intended to handle content-rich attachments, such as multimedia attachments. As a result, users still experience unacceptable download times and connection frustrations.

Because of the ever-increasing popularity of both e-mail and portable wireless devices, much interest exists in finding a solution to these problems.

### GLOSSARY

CDPD: CDPD is an acronym for Cellular Digital Packet Data, a data transmission technology developed for use on cellular phone frequencies. CDPD uses unused cellular channels (in the 800- to 900-MHz range) to transmit data in packets. This technology offers data transfer rates of up to 19.2 Kbps, quicker call set up, and better error correction than using modems on an analog cellular channel.

CGI: CGI is an acronym for Common Gateway Interface, a specification for transferring information between a World Wide Web server and a CGI program. A CGI program is any program designed to accept and return data that conforms to the CGI specification. The program could be written in any programming language, including C, Perl, Java, or Visual Basic.

JPEG: JPEG is an acronym for Joint Photographic Experts Group, and is pronounced “jay-peg.” JPEG is a lossy compression technique for color images. Although it can reduce files sizes to about 5% of their normal size, some detail is lost in the compression.

LAN: LAN is an acronym for a Local Area Network of computers that spans a relatively small area. Most LANs are confined to a single building or group of buildings. However, one LAN can be connected to other LANs over any distance via telephone lines and radio waves. A system of LANs connected in this way is called a wide-area network (WAN).

MIME: MIME is an acronym for Multipurpose Internet Mail Extensions, a specification for formatting non-ASCII messages so that they can be sent over the Internet. Many e-mail clients now support MIME, which enables them to send/receive graphics, audio, and video files via the Internet mail system. In addition, MIME supports messages in character sets other than ASCII. There are many predefined MIME types, such as GIF graphics files and PostScript files. It is also possible to define your own MIME types. The following RFC's define MIME:

RFC 2045: MIME Part One: Format of Internet Message Bodies

RFC 2046: MIME Part Two: Media Types

RFC 2047: MIME Part Three: Message Header Extensions for Non-ASCII Text

RFC 2048: MIME Part Four: Registration Procedures

RFC 2049: MIME Part Five: Conformance Criteria and Examples

The foregoing are hereby incorporated by reference.

PCS: PCS is an acronym for Personal Communications Service and is the U.S. Federal Communications Commission (FCC) term used to describe a set of digital cellular technologies being deployed in the U.S. PCS works over CDMA (also called IS-95), GSM, and North American TDMA (also called IS-136) air interfaces. Three of the most important distinguishing features of PCS systems are: they are completely digital, they operate at the

1900 MHz frequency range, and they can be used internationally. PCS is a second generation mobile communications technology.

PNG: PNG is an acronym for Portable Network Graphics, a bit-mapped graphics format similar to GIF. PNG was approved as a standard by the World Wide Web consortium to replace GIF because GIF uses a patented data compression algorithm called LZW. In contrast, PNG is completely patent-free and license-free. The most recent versions of Netscape Navigator and Microsoft Internet Explorer now support PNG image formats.

Perl: Perl is an acronym for Practical Extraction and Report Language. Perl is a programming language designed for processing text. Because of its strong text processing abilities, Perl has become one of the most popular languages for writing CGI scripts, which are processes running on the server platform of a Web service. Perl is an interpretive language, which makes it easy to build and test simple programs.

SMTP: Short for Simple Mail Transfer Protocol, a protocol for sending e-mail messages between servers. Most e-mail systems that send mail over the Internet use SMTP to send messages from one server to another; the messages can then be retrieved with an e-mail client using either POP or IMAP. In addition, SMTP is generally used to send messages from a mail client to a mail server.

URL: Abbreviation of Uniform Resource Locator, the global address of documents and other resources on the World Wide Web. The first part of the address indicates what protocol to use, and the second part specifies the IP address or the domain name where the resource is located.

WAP: Abbreviation for Wireless Application Protocol. WAP is a communication protocol, not unlike TCP/IP, that was developed by a consortium of wireless companies, including Motorola, Ericsson, and Nokia, for transmitting data over wireless networks. For a description of WAP, see e.g., Mann, S., The Wireless Application Protocol, Dr. Dobb's Journal, pp. 56-66, October 1999, the disclosure of which is hereby incorporated by reference.

WAV: WAV is the format for storing sound in files developed jointly by Microsoft and IBM.

Support for WAV files was built into Windows 95, making it the de facto standard for sound on PCs. WAV sound files end with a “.wav” file name extension and can be played by nearly all Windows (and Internet) applications that support sound.

Ymodem: Ymodem is an asynchronous communications protocol that extends Xmodem by increasing the transfer block size and by supporting batch file transfers. This enables the sender to specify a list of files and send them all at one time. With Xmodem, the sender can send only one file at a time.

Zmodem: Zmodem is an asynchronous communications protocol that provides faster data transfer rates and better error detection than Xmodem. In particular, Zmodem supports larger block sizes and enables the transfer to resume where it left off following a communications failure.

WAV: WAV is the format for storing sound in files developed jointly by Microsoft and IBM. Support for WAV files was built into Windows 95, making it the de facto standard for sound on PCs. WAV sound files end with a “.wav” file name extension and can be played by nearly all Windows (and Internet) applications that support sound.

### SUMMARY OF THE INVENTION

A system is described that provides an optimization of e-mail deliveries to allow the recipients to receive e-mail attachments at a time, of a size, and in a format as desired. This includes protecting a given e-mail recipient, who is typically using a handheld wireless client device, from confronting an oversized attachment, and further includes providing the recipient with options for how to receive large e-mail attachments. Additionally, the present invention includes built-in intelligence for filtering e-mail attachments according to the capabilities of a particular recipient's device type and/or Internet bandwidth.

The present invention removes the problematic (or potentially problematic) attachment from the e-mail message, stores the attachment in a network repository, and reconstitutes the e-mail's message (body) with multiple alternative means for processing/consuming the object from the detached attachment. These multiple alternative means include five primary modifiable policies. The recipient may not receive any overly-large attachments with subsequent message deliveries. The recipient may receive, as a substitute, a transformation of the object in the attachment that is better suited for the type of recipient client device. The recipient may receive a link (e.g., URL), that references the storage address in the network repository, for the original (e.g., full-resolution) attachment for subsequent accessing from a more capable client device. The recipient may receive a link for the reformatted attachment for subsequent processing/consuming from the current client device. The recipient may receive, as a substitute, a transformation of the object in the attachment that is more friendly for the least capable of those types of client devices having previously received messages from an implementation of the present invention.

The capabilities of the recipient's type of client device are the limiting factor defining the appropriate degree of transformation to apply to subsequent message attachments for delivery to the device. During operation, a delivery server can determine the capabilities of a particular recipient's device type and/or Internet bandwidth by either interaction with the recipient or from database records of antecedent interaction(s) with the recipient. This determination may be based on previously-set configuration information (e.g., using user-specified configuration settings), or may be detected dynamically (e.g., during a request to retrieve e-mail messages from a particular user's e-mail in-box). In instances where compatibility with existing communication protocols is desired, client device configuration information is specified by the recipient user beforehand, for instance, via a Web-page data entry form. If compatibility with existing communication protocols is not required, a communication protocol may be employed that includes protocol commands that allow the capabilities of a target device to be determined without ever interacting with the user.

In cases wherein the capabilities of the client device are determined by database records of antecedent user interactions and where the user uses multiple types of client devices to receive messages from the system, the present invention applies a transformation on the current attachment that corresponds to the least capable in the set of those multiple devices. When applying a protocol allowing determination of recipient device type (e.g., Wireless Application Protocol (WAP)), the present invention may automatically perform the optimum transformation/formatting specific to the targeted type of device, thereby rendering user input unnecessary. In such a WAP-enabled embodiment, if the user used several types of client devices to receive e-mail, the system is capable of automatically delivering and storing multiple formats of all the multimedia attachments.

The preferred embodiment re-packages JPEG image attachments in particular. The preferred embodiment determines whether a message's attachments are JPEG images, and in these cases, whether JPEG attachments are valid JPEG files. The types of transformations applied to the objects in the JPEG attachments include converting those objects to alternative image formats (e.g., from JPEG to GIF) and/or decreasing their resolution (and therefore the size). Finally, the preferred embodiment stores the copy of the object in the original attachment at a facility accessible by a photo Web site, where a “share” event/operation (i.e., specifying that the image is to be shared, from the network repository, among multiple users) is created for it.

### BRIEF DESCRIPTION OF THE DRAWINGS

FIG. 1 is a block diagram of a computer system in which the present invention may be embodied.

FIG. 2 is a block diagram of a software system for controlling the operation of the computer system of FIG. 1.

FIG. 3 is a high-level block diagram illustrating the network configuration of the multiple components in the system.

FIG. 4 is a block diagram illustrating a lower level of software sub-components within the core component of the system.

FIGS. 5A-B comprise a flowchart illustrating the sequential steps in the process of re-packaging e-mail that contains an attachment(s).

FIG. 6 is a flowchart illustrating the sequential steps in the process of receiving e-mail from the present invention via the URL.

### DETAILED DESCRIPTION OF A PREFERRED EMBODIMENT

The following description will focus on the presently-preferred embodiment of the present invention, which is implemented in a portable computing device operating in a wireless network with Internet connectivity, for interaction with a desktop and/or server computer, both of which may run an appropriate version of Microsoft® Windows on an IBM-compatible PC. The present invention, however, is not limited to any particular one application or any particular environment. Instead, those skilled in the art will find that the system and methods of the present invention may be advantageously embodied on a variety of different platforms, including Macintosh, Linux, BeOS, Solaris, UNIX, NextStep, and the like. Therefore, the description of the exemplary embodiments which follows is for purposes of illustration and not limitation.

Computer-Based Implementation

A. Basic System Hardware (e.g., for desktop and server computers)

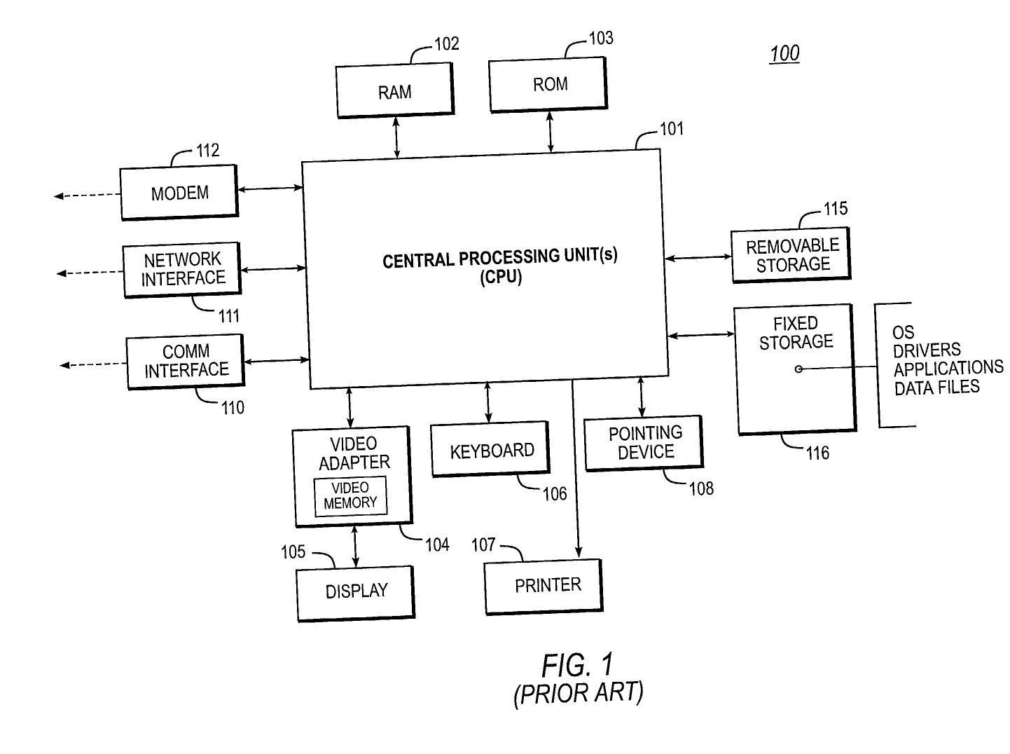

Portions of the present invention may be implemented on a conventional or general-purpose computer system, such as an IBM-compatible personal computer (PC), server computer, and/or portable (hand-held) computer (“pocket” PC or PDA device). FIG. 1 is a very general block diagram of an IBM-compatible system 100. As shown, system 100 comprises a central processing unit(s) (CPU) or processor (s) 101 coupled to a random-access memory (RAM) 102, a read-only memory (ROM) 103, a keyboard 106, a pointing device 108, a display or video adapter 104 connected to a display device 105, a removable (mass) storage device 115 (e.g., floppy disk, CD-ROM, CD-R, CD-RW, or the like), a fixed (mass) storage device 116 (e.g., hard disk), a communication port(s) or interface(s) 110, a modem 112, and a network interface card (NIC) or controller 111 (e.g., Ethernet). Although not shown separately, a real-time system clock is included with the system 100, in a conventional manner.

CPU 101 comprises a processor of the Intel Pentium® family of microprocessors. However, any other suitable microprocessor or microcomputer may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixteen megabytes or more is employed. More or less memory may be used without departing from the scope of the present invention. The read-only memory (ROM) 103 contains the basic input output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the storage device or mass storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the display screen 105. Likewise, the pointing device 108, such as a mouse, track ball, pen device, or the like, permits selection and manipulation of objects on the display screen. In this manner, these input devices support manual user input for any process running on the system.

The computer system 100 displays text and/or graphic images and other data on the display device 105. Display device 105 is driven by the video adapter 104, which is interposed between the display 105 and the system. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP Laserjet® printer (available from Hewlett-Packard of Palo Alto, Calif.), for creating hard copy images of output of the system.

The system itself communicates with other devices (e.g., other computers) via the network interface card (NIC) 111 connected to a network (e.g., Ethernet network), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (“comm”) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers, server, and portable (hand-held) computers are available from a variety of vendors. Representative vendors include Dell Computers of Round Rock, Tex., Compaq Computers of Houston, Tex., IBM of Armonk, N.Y., and Palm, Inc. of Santa Clara, Calif. Other suitable computers include Apple-compatible computers (e.g., Macintosh), which are available from Apple Computer of Cupertino, Calif., and Sun Solaris workstations, which are available from Sun Microsystems of Mountain View, Calif.

B. Basic System Software

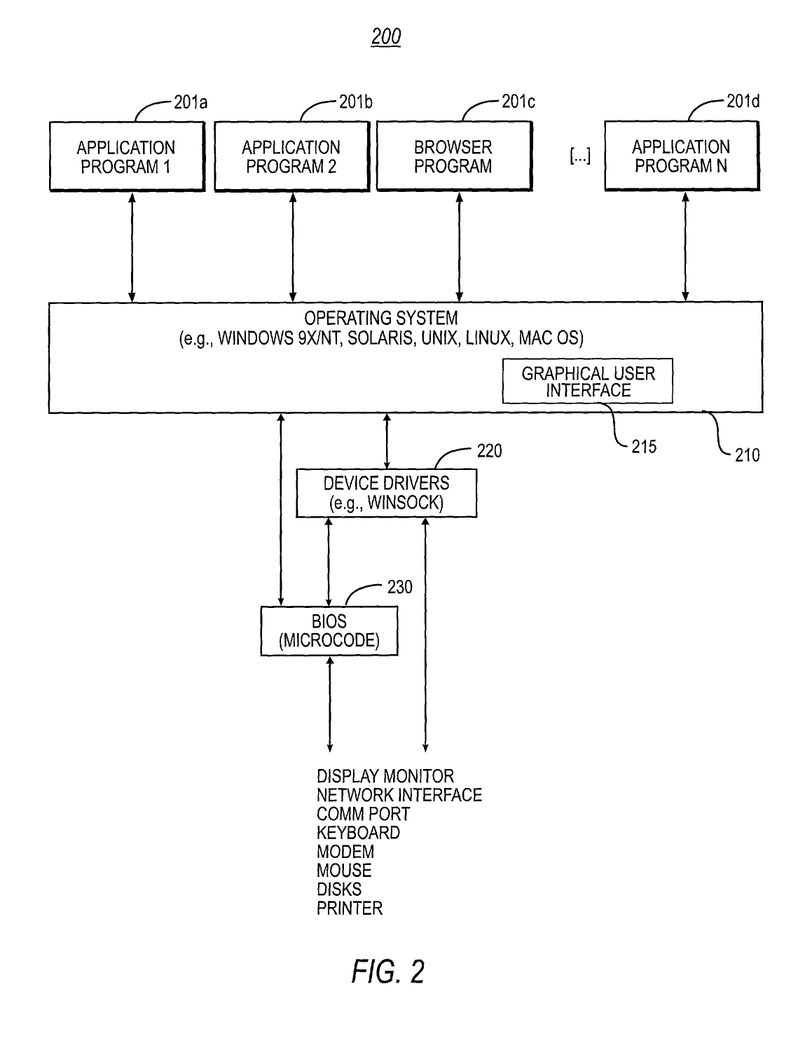

Illustrated in FIG. 2, a computer software system 200 is provided for directing the operation of the computer system 100. Software system 200, which is stored in system memory (RAM) 102 and on fixed storage (e.g., hard disk, and/or embedded ROM) 116, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d) may be “loaded” (i.e., transferred from fixed storage 116 into memory 102) for execution by the system 100.

System 200 includes a graphical user interface (GUI) 215, for receiving user commands and data in a graphical (e.g., “point-and-click”) fashion. These inputs, in turn, may be acted upon by the system 100 in accordance with instructions from operating system 210, and/or client application module(s) 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver—Windows' implementation of a TCP/IP stack) and the system BIOS microcode 230 (i.e., ROM-based microcode), particularly when interfacing with peripheral devices. OS 210 can be provided by a conventional operating system, such as Microsoft® Windows 9x, Microsoft® Windows NT, Microsoft® Pocket PC, Microsoft® Windows 2000, or Microsoft® Windows XP, all available from Microsoft Corporation of Redmond, Wash. Alternatively, OS 210 can also be an alternative operating system, such as the previously-mentioned operating systems.

The above-described computer hardware and software are presented for purposes of illustrating the basic underlying desktop, server, and portable (hand-held) computer components that may be employed for implementing the present invention. For purposes of discussion, the following description will present examples in which it will be assumed that there exists a “server” (e.g., host computer, such as a Web server) which communicates with one or more “clients” (e.g., portable or hand-held computer, such as a personal digital assistant or PDA device). The present invention, however, is not limited to any particular environment or device configuration. In particular, a client/server or target/host distinction is not necessary to the invention, but is used to provide a framework for discussion. Instead, the present invention may be implemented in any type of system architecture or processing environment capable of supporting the methodologies of the present invention presented in detail below.

Optimizing Delivery and Processing of e-mail Attachments for Disparate Client Devices

A. Overview

The present invention provides supplementary e-mail-delivery processing adding value to the established e-mail systems serving their senders and receivers. This includes protecting a given e-mail recipient, who is typically using a handheld wireless client device or other portable device, from confronting an oversized attachment, and further includes providing the recipient with options for how to receive large e-mail attachments. Additionally, the present invention includes built-in intelligence for filtering e-mail attachments according to the capabilities of a particular recipient's device type.

More particularly, the invention includes a methodology for modifying functionality at a given mail server (e.g., SMTP server) to detect whenever an incoming e-mail includes an attachment that may exceed the capabilities of a given client device that is to receive that e-mail. Typically, such an attachment would be large and/or comprise multimedia or other rich content. Method steps are provided to remove the problematic attachment from the e-mail message, store the attachment in a repository (e.g., local to or accessible by the server), and replace the attachment in the e-mail's message (body) with a link (e.g., URL) that references the network storage address. The mail server then makes the adjusted or modified e-mail message (i.e., with the attachment “detached”) available to the recipient. The recipient can then elect to later use that link (URL) to access the attachment, for instance from a more fully-featured device such as a desktop PC (e.g., “personal computer”) that can run a browser to view or otherwise process the attachment.

During operation, a server (which embodies the present invention) determines the type of device the recipient is using. This determination may be based on previously-set configuration information (e.g., using user-specified configuration settings), or may be detected dynamically (e.g., during a request to retrieve e-mail messages from a particular user's e-mail in-box). In instances where compatibility with existing communication protocols (e.g., SMTP) is desired, client device configuration information is specified by the recipient user beforehand, for instance, via a Web-page data entry form. If compatibility with existing communication protocols is not required, a communication protocol may be employed that includes protocol commands that allow the capabilities of a target device to be determined.

In the currently-preferred embodiment, this device-capability determination includes determining a type (e.g., color or grayscale, JPEG or BMP, or the like) and size (e.g., resolution) of objects that the recipient's device can handle (e.g., display). For example, if a user of a Palm™ V handheld device receives an e-mail with a JPEG image attachment, the mail server (modified in accordance with the present invention) determines, based on either configuration information or run-time determination, the best resolution available for displaying a JPEG image on that type of device. The server can transform and/or reformat the JPEG image, which may be originally formatted as a 24-bit color, 640×480 pixel image, down to an 8-bit color image with a lesser resolution, thereby being compatible and optimal for Palm V output. If desired, the user can override and/or modify this determination. Typically, the user will choose to have these settings apply to all subsequent sessions for the given device, but is given the option to override the settings, as desired. For example, the recipient can authorize, e.g., via a Web-based configuration page, that all subsequent e-mail messages with JPEG attachments requested by this device type be reformatted to the appropriate characteristics (e.g., resolution and size) for this particular device (e.g., Palm V).

To retrieve the attachment, the recipient can click on the link or URL accompanying the message. In the instance that the link is invoked from the portable client device (e.g., Palm V), the server provides the Palm V with a modified version of the original attachment. The attachment itself is reformatted for optimum rendering/processing on the client device. On the other hand, the link may be invoked from a more capable device (e.g., desktop PC), for accessing the original attachment (or copy thereof). In both cases, the system downloads the richest content that the currently-receiving device is capable of handling (assuming the recipient has not requested otherwise).

Optionally, the recipient user can elect to have attachments automatically formatted/transformed for a given type of client device. Here, the original attachment is not replaced with a link but, instead, is replaced with an attachment that is automatically formatted for optimum rendering/processing at the type of device specified by the user.

Therefore, in this fashion, the mail server performs automatic formatting of attachments (e.g., as to image size, frame size, file format, resolution, color/monochromatic, or the like) based on determining a given target device's capabilities (and/or applying user-specified formatting), including transforming into different formats (e.g., JPEG into GIF) as required by a particular target device.

The recipient can explicitly specify a subsequent delivery scheme for e-mail attachments via a browser when he or she clicks on the URL to view an antecedent attachment. If this system is deployed as an e-commercial subscription service, the user can also register his or her configured preference during subscription registration/interaction. In either scenario, the user has the following exemplary options for a default mail delivery with attachments:

1. To not receive any (large) attachments with his or her message deliveries in general.

2. To receive, by default, reformatted attachments in general

3. To receive by RLs for reformatted attachments in general

4. To receive URLs for original (full-resolution) attachment(s) to defer viewing the original attachment(s) on a more fully-featured device.

5. To receive an attachment optimized for the least-common denominator of all known device types for that user.

If the recipient has used multiple types of client devices to receive e-mail from this system, and they are associated with the recipient (e.g., tracked in a database), the preferred embodiment returns the “least common denominator” formatted attachments with the body of the e-mail. A least common denominator format for image attachments would, for example, reformat/transform the image to include the smallest number of colors and the lowest resolution compatible with all of the recipient's registered client device types (i.e., registered with the database). In such a case, the transformation would correspond to the device with the least capabilities for displaying and downloading an image.

When applying a protocol allowing determination of recipient device type (e.g., Wireless Application Protocol (WAP)), the present invention may automatically perform the optimum transformation specific to the targeted type of device, thereby rendering user input unnecessary. In such a WAP-enabled embodiment, if the user used several types of client devices to receive e-mail, the system is capable of automatically delivering and storing multiple formats of all the multimedia attachments.

B. Transforming e-mail Attachments

1. System Architecture

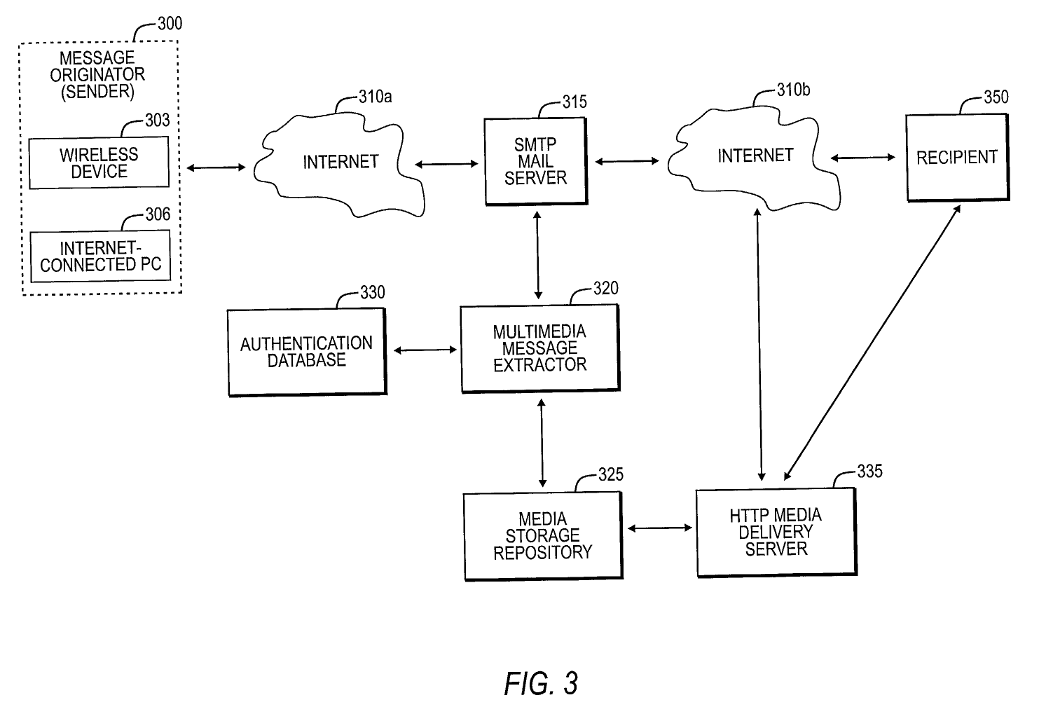

FIG. 3 is a high-level block diagram illustrating an e-mail system modified in accordance with the present invention. As shown in FIG. 3, the working environment of the system includes a message originator (i.e., sender) 300, for instance using a wireless device 303 and/or an Internet-connected PC 306, the public Internet (shown at 310a) connecting a sender to a Sendmail SMTP mail server 315 (available from Sendmail, Inc. of Emeryville, Calif.), a multimedia message extractor 320, a media storage repository 325 (which consists of a media database and a large storage disk), an authentication database 330, an HTTP media delivery server 335, and the public Internet (again shown at 310b) connecting the mail services to a recipient 350, for instance using another wireless device and/or an Internet-connected PC (not shown). (Internet 310a and Internet 310b both represent the public Internet, but are shown as separate components for simplification of the diagram.) If desired, the public Internet components may instead be a LAN or other private network depending upon the type of network serviced by the mail server.

For further description of Sendmail itself, see, e.g., Sendmail® for NT User Guide, Part Number DOC-SMN-300-WNT-MAN-0999, available from Sendmail, Inc. of Emeryville, Calif., the disclosure of which is hereby incorporated by reference. Further description of the basic architecture and operation of e-mail systems is available in the technical and trade literature; see e.g., the following RFC (Request For Comments) documents:

RFC821 Simple Mail Transfer Protocol (SMTP)

RFC822 Standard for the Format of ARPA Internet Text Messages

RFC974 Mail Routing and the Domain System

RFC937, RFC1081 Post Office Protocol version 3 (POP3)

RFC1123 Requirements for Internet Hosts—Application and Support

RFC1725 Post Office Protocol version 3 (POP3)

RFC2033 Local Mail Transfer Protocol (LMTP)

RFC2060, RFC2061 Internet Message Access Protocol (IMAP)

RFC2246 The TLS Protocol, version 1.0

RFC2487 SMTP Service Extension for Secure SMTP over TLS

RFCs are numbered Internet informational documents and standards widely followed by commercial software and freeware in the Internet and UNIX communities. The RFCs are unusual in that they are floated by technical experts acting on their own initiative and reviewed by the Internet at large, rather than formally promulgated through an institution such as ANSI. For this reason, they remain known as RFCs even once they are adopted as standards. The above-listed RFC documents are currently available via the Internet (e.g., at http://www.ietf.org/rfc), the disclosures of which are hereby incorporated by reference.

In basic system operation, the message originator (sender) 300 sends a message along with an attachment across the Internet 310a to the recipient 350. If the network does not involve the Internet, then the message is sent across whatever network is being employed. En route to the recipient the e-mail goes to a standard SMTP mail server (e.g., Sendmail) 315, which filters mail with the multimedia message extractor module 320. In a preferred embodiment employing Sendmail for the SMTP mail server, Sendmail's plug-in architecture is employed. Here, the multimedia message extractor 320 talks to the Sendmail SMTP mail server 315 (e.g., version 8.10, or later), which includes support for “Milter” plug-ins. The Sendmail Mail Filter API (Milter) provides an interface for third-party software to validate and modify messages as they pass through the mail transport system. Filters can process messages' connection (IP) information, envelope protocol elements, message headers, and/or message body contents, and modify a message's recipients, headers, and body. Using Sendmail's corresponding configuration file, one can specify which filters are to be applied, and in what order, allowing an administrator to combine multiple independently-developed filters. Thus in this manner, the Milter plug-in architecture allows a developer to, in effect, plug into the e-mail delivery system for inserting custom subroutines or other processing. Accordingly, in the preferred embodiment, the multimedia message extractor 320 is created as a Sendmail-compatible Milter plug-in. For further description of Sendmail's Milter, see, e.g., “Filtering Mail with Sendmail” available from Sendmail, Inc. (and currently available via the Internet at http://www.sendmail.com/de/partner/resources/development/milter_api/), the disclosure of which is hereby incorporated by reference.

The multimedia message extractor 320 also communicates with the authentication database 330 to ensure that the sender is registered with the system, and if not, may optionally create an account for the user automatically. The authentication database 330 may also know the device type of the recipient 350 at this point (e.g., based on user registration). Once authentication has been provided by the authentication database 330, the media storage repository 325 may be invoked to reformat/transform a particular target attachment (i.e., according to target device criteria/capabilities), including storing both the original version and the reformatted version. The multimedia message extractor 320 copies the original attachment, and a reformatted copy, if one was made, to the media storage repository 325. For an example of a repository suitable for storing media objects, see, e.g., commonly-owned application Ser. No. 09/814,159 (Docket No. LS/0011.00), filed Mar. 20, 2001, entitled “Media Asset Management System”.

When the recipient 350 receives the e-mail message and wishes to view the attachment, he or she connects to the HTTP media delivery server 335 by invoking the link (e.g., clicking on the URL) that the multimedia message extractor 320 added to the message. The HTTP media delivery server 335 is also connected to the media storage repository 325. If the link (in conjunction with both the user name and password entered by the recipient 350) is found in the media storage repository 325, the HTTP media delivery server 335 returns the media object tailored to the appropriate display format for the previously-registered device type for the recipient 350. Also, the recipient 350 has the option to receive the attachment in its original format (i.e., full resolution) if desired (e.g., the reformatted attachment does not match the device type the recipient 350 is currently using).

2. Multimedia Message Extractor Architecture

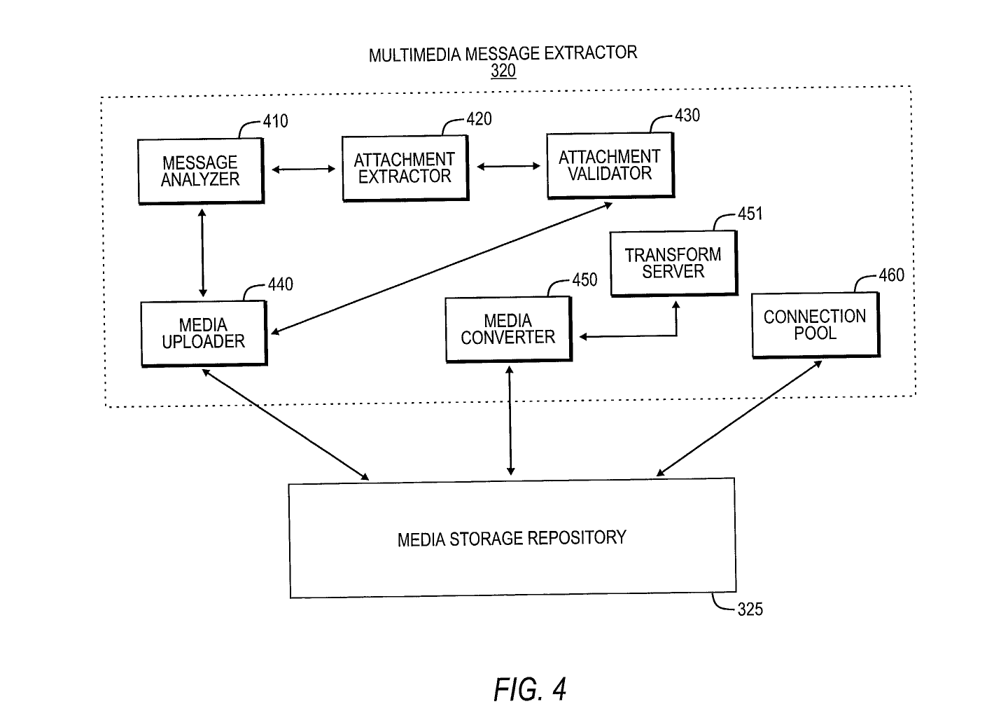

FIG. 4 is a block diagram illustrating the multimedia message extractor module 320 (shown above in FIG. 3) in further detail. As shown, the multimedia message extractor 320 itself includes a message analyzer 410, an attachment extractor 420, an attachment validator 430, a media uploader 440, a media converter 450, and a connection pool 460. As also shown, these latter components interface with the media storage repository 325 (shown above in FIG. 3), which includes a media database and disk storage supporting a file system of digital images.

Whenever a message is made available (e.g., via Sendmail Milter interface) to the multimedia message extractor 320, the message analyzer 410 extracts the sender data and the recipient data from the message header, caches the body text of the message, and passes the attachment to the attachment extractor 420; if desired, however, message detachment may be deferred (e.g., until a request is received from a recipient to retrieve incoming mail from a POP 3 mail server). The message analyzer 410 authenticates the sender by checking with the 320 authentication database (previously shown at 330 in FIG. 3) to see if this sender is registered as a valid sender. Senders are not required to physically belong to the network serviced by the SMTP mail server 315. Senders can instead, for example, register with the system by schemes such as subscriptions to this service. If the sender is not registered with the system, the original message is returned to the sender.

In the case that the sender is authenticated (i.e., normal case), the message analyzer 410 checks the recipient data with the authentication database 330 to determine if this recipient has previously visited the system, such as having clicked on a URL received in a message from a registered sender. If the recipient data is present in the authentication database 330, the message analyzer 410 can easily retrieve the recipient's device type and display parameters. Then the message analyzer 410 determines if the attachment type (e.g., JPEG, text, audio WAV file, MPEG, or the like) is supported by that recipient's system. In the currently-preferred embodiment, the message analyzer 410 saves all the data for the sender, recipient, body text, and attachment(s) in a data structure, which the preferred embodiment implements in Perl (described in further detail below).

The message analyzer 410 passes this data structure to the attachment extractor 420, which is capable of tailoring attachments, particularly media attachments. In the currently-preferred embodiment, which is optimized for processing media objects, the attachment extractor 420 looks at the type of the media object in each attachment. If the type of the media object is supported by the system, then that media object may be removed from the MIME structure (represented internally as a Perl/MIME component), saved to disk, and referenced in the media database in the media storage repository 325. If desired, this removal or detachment may be deferred until a later point in time (e.g., at the time when the message is to be viewed on the recipient's device). A modified media attachment can be put back into the same Perl/MIME component when the attachment is downloaded to the recipient. Then the attachment validator 430 determines if the media object (e.g., image) in each attachment is valid for its type. For example, if the media object is specified as a JPEG file, the attachment validator 430 ensures that it is a valid JPEG. (e.g., it contains a valid JPEG header and will decompress as a JPEG image). Similarly, if the media object is specified as a WAV (compressed audio) file, the attachment validator 430 ensures that the WAV header signature at the beginning of the WAV file is in fact valid.

The attachment validator 430 passes valid media objects to the media uploader 440. The attachment's metadata is passed to the media uploader 440, which uploads a “media block” to the media storage repository 325. All of the elements of the media attachment, the media object and its metadata, that were extracted and evaluated, constitute the media block. The media uploader 440 stores the media object itself on disk, and stores the metadata, along with the address of the media object on the disk, in the media database at the media storage repository 325. The media storage repository 325 generates a unique number to represent a uniquely identifiable link (e.g., URL) for retrieving the un-transformed media object in its original format. This unique number includes both a primary key (i.e., unique ID) used for accessing the media object in the media database and any (image) transformation parameters corresponding to the type of device the recipient is using. The media storage repository 325 returns the link (URL) to the media uploader 440. The connection pool 460 of the multimedia message extractor maintains multiple open connections between the media uploader 440 and the media storage repository 325 to expedite the response time of the service.

The media converter 450 component serves to check the authentication database 330 to determine whether the recipient has any device-type specifications of the format, that may be required for appropriate rendering/processing at his or her client device. If this information exists, the media converter 450 invokes a transform server 451 (embodied as a sub-component of the media storage repository 325), to convert the original media object on-the-fly (e.g., re-compress the media object to recipient-based parameters). The transform server 451, which provides standard image transformation capability (e.g., from one image format to another), may be implemented using existing graphics libraries, such as LeadTools available from Lead Technologies, Inc. of Charlotte, N.C.

The media converter 450 stores a copy of the converted media object in the media database. The media uploader 440 stores the corresponding link (URL) in the database, and returns the link and the transformed media object to the multimedia message extractor (as shown at 320 in FIG. 3). The multimedia message extractor 320 inserts the link (for the un-transformed media object) and a copy of the transformed media object (if said transformation occurred) back into the attachment, and returns the re-packaged e-mail back to the SMTP mail server (as shown at 315 in FIG. 3) for delivery to the recipient. If the recipient had earlier opted to receive transformed attachments automatically with each delivery, he or she can view the attachment on the handheld client device, and optionally choose to later use the link to view the full-size attachment on a more full-bodied client device.

The transform server 451 itself is an engine that transforms or converts image information. For example, it includes methods for receiving an input image, typically in a bitmap format, accompanied by parameters that specify the type of transformation desired, and generating an output image corresponding to the specified conversion. The parameters may specify the input image format, the output image format, the size or resolution fidelity of the output image, and the operation(s) to be performed. With this information, the transform server 451 decodes, or decompresses, the input image, scales the image to the specified size, applies the specified operation(s), and finally, re-encodes, or compresses) the modified input image to the specified output format.

For example, the transform server 451 may receive a JPEG input image and a request to perform an operation that sharpens the image and to encode the output image with a compression ratio of 8-bits per pixel in a PNG image format. The transform server 451 decodes the input image using the public domain libpeg, which is available from the Independent JPEG Users' Group at their Web site (currently at http://www.ijg.org). The decoded image is sharpened using a C++ method, Sharpen( ), as described below. The enhanced image is then “dithered” to 8-bits per pixel using error diffusion, which is a standard method (see, e.g., Foley, Van Dam, et al., Computer Graphics: Principles and Practice, Addison Wesley, 1990, which is hereby incorporated by reference) The 8-bits/pixel image is encoded in a PNG image format using libpng, which is provided as public domain code available (currently at ftp://ftp.freesoftware.com/pub/png). With the specified transformation completed, the HTTP media delivery may return a transformed image (e.g., PNG image).

The preferred embodiment of the transform server defines specific APIs for many enhancement operations, including, for example, antique( ), aspectcrop( ), aspectcroppreview( ), autofix( ), background( ), backlight( ), blur( ), brighten( ), bulge( ), card( ), cartoon( ), contrast( ), crop( ), croppreview( ), dropshadow( ), emboss( ), eps( ), experiment( ), findedges( ), gray( ), hflip( ), instantfix( ), intcrop( ), intcroppreview( ), introtate( ), invert( ), layer( ), neon( ), noise( ), outline( ), paint( ), psych( ), redeye( ), saturate( ), scale( ), sharpen( ), size( ), softfocus( ), text( ), textbox( ), twist( ), vflip( ), wave( ), and whitebalance( ). Input image formats include JPEG, PPF, PNG, BMP, WBMP, TIFF, PDB (for systems using the Palm operating system), and the like. The preferred embodiment generates output images in many types of formats, including JPEG (RGB only), PNG (1, 2, 4, or 8 bit color or grayscale, or 24 bit color), BMP (1, 2, 4, or 8 bit color or grayscale, or 24 bit color), WBMP (1 bit black and white), TIFF (24 bit color), GIF (1, 2, 4, or 8 bit color or grayscale), PDB (1, 2, 4, or 8 bit color or grayscale), and the like.

The Sharpen enhancement method itself may be constructed as follows using the C++ programming language (e.g., using Microsoft Visual C++, available from Microsoft Corporation of Redmond, Wash.)

| 1: | //------------------------------------------------------------------- | |
|---|---|---|
| 2: | // Name: | CImageServer: :Sharpen |

| 3: | //------------------------------------------------------------------- | |
|---|---|---|
| 4: | void CImageServer: :Sharpen(int amount_pos, | |
| | /* pos diffs are enhanced by this amount */ | |
| 5: | | int amount_neg, |
| | /* neg diffs are enhanced by this amount */ | |
| 6: | | int nbhd_width, |
| | /* nbhd to consider */ | |
| 7: | | int mask_thresh_pos, |
| /* | do not enhance pos diffs. less than mask_thresh_pos/256 */ | |
| 8: | | int mask_thresh_neg |

| /* | do not enhance pos diffs. less than mask_thresh_pos/256 */ | |
|---|---|---|
| 9: | | |
| 10: | { | |
| 11: | | |
| 12: | __LSURF_PROFILE_START; | |
| 13: | | |
| 14: | //---------------------------------------------- | |
| 15: | // Do nothing for “wild” parameters | |
| 16: | //---------------------------------------------- | |
| 17: | if (amount_pos < 0) return; | |
| 18: | if (amount_neg < 0) return; | |
| 19: | if (mask_thresh_pos < 0) return; | |
| 20: | if (mask thresh_neg < 0) return; | |
| 21: | | |
| 22: | //---------------------------------------------- | |
| 23: | // Color space: Use YCrCb Note: Only Y is sharpened | |
| 24: | //---------------------------------------------- | |
| 25: | UsingColorSpace(COLOR_SPACE_YCrCb, READ_WRITE); | |
| 26: | | |
| 27: | //---------------------------------------------- | |
| 28: | // Compute parameters | |
| 29: | //---------------------------------------------- | |
| 30: | /// Internal parameters | |
| 31: | const I32 MULT_PRECISION = | 10; |

///< precision for multiplications

| | | |
|---|---|---|
| 32: | const I32 MULT_FACTOR = | MULT_PRECISION; |

| 33: | /// Some parameters have to be adjusted perimage image precision | |
|---|---|---|
| 34: | int 1s = | precision-8; |

assert(1s >= 0);

| 35: | int mask_thresh; | |
|---|---|---|
| 36: | mask_thresh_pos = | mask_thresh_pos<<1s; |
| 37: | mask_thresh_neg = | mask_thresh_neg<<1s; |

| | | |
|---|---|---|
| 38: | int max_val= | (1<<precision)-1; |
| 39: | /// Derived parameters | |

| | | |
|---|---|---|
| 40: | int nbhd_half_width = | (nbhd_width/2); |
| 41: | int nbhd_pixels | (nbhd_width*nbhd_width); |
| 42: | I32 mask_scale; | |
| 43: | I32 mask_scalepos = | (I32) ((amount_pos / |

100.0)*MULT_FACTOR);

| | | |
|---|---|---|
| 44: | I32 mask_scale neg = | (I32) ((amount_neg / |

100.0)*MULT_FACTOR);

| 45: | UI32 nbhdpixels_reciprocal = MULT_FACTOR/nbhd_pixels; | |
|---|---|---|
| 46: | | |
| 47: | //---------------------------------------------- | |
| 48: | // Pad the image | |
| 49: | //---------------------------------------------- | |
| 50: | PadImage (COLOR_SPACE_YCrCb); | |
| 51: | | |
| 52: | //---------------------------------------------- | |
| 53: | // Allocate space for new Y channel | |
| 54: | //---------------------------------------------- | |
| 55: | I16 *pad_Yout | =(I16 *) malloc(pad_size * sizeof (I16)); |
| 56: | I16 *Yout | =pad_Yout +(pad * pad_width) + pad; |
| 57: | | |
| 58: | //---------------------------------------------- | |
| 59: | // Unsharp mask of Y channel | |
| 60: | //---------------------------------------------- | |
| 61: | int Y_ave, Y_new, Y_diff, Y_abs_diff; | |
| 62: | int r, c, r_nbhd, c_nbhd; | |
| 63: | int Y; | |
| 64: | | |
| 65: | I16 *line_in | =Yarray; |
| 66: | I16 *line_out | =Yout; |

| 67: | I16 *line_nbr; | |
|---|---|---|
| 68: | UI32 pad_width2 = 2 * pad_width; | |
| 69: | switch(nbhd_width) | |
| 70: | { | |
| 71: | case 3: | |
| 72: | | for (r=0; r < height; r++) |
| 73: | | { |

| | |
|---|---|
| 74: | for (c=0; c < width; c++) |
| 75: | { |

| 76: | Y =line_in[c]; | |
|---|---|---|
| 77: | | |
| 78: | //------------------------------------------------------- | |
| 79: | // Determine the average of the neighborhood | |
| 80: | // | start with a negative of the current pixel |
| 81: | // | as it will be added later in the following loop |

| | |
|---|---|
| 82: | //------------------------------------------------------- |
| 83: | Y_ave = (1 * ((I32) line_in [0-pad_width +c-1]))+ |

| | |
|---|---|
| 84: | (1 * ((I32) line_in[0-pad_width +c]))+ |
| 85: | (1 * ((I32) line_in[0-pad_width +c+1]))+ |
| 86: | (1 * ((I32) line_in[c-1]))+ |
| 87: | (1 * ((I32) line_in[c]))+ |
| 88: | (1 * ((I32) line_in[c+1]))+ |
| 89: | (1 * ((I32) line_in[pad_width +c-1]))+ |
| 90: | (1 * ((I32) line_in[pad_width +c]))+ |
| 91: | (1 * ((I32) line_in[pad_width +c+1))); |

| 92: | Y_ave = (Y_ave * nbhd_pixels_reciprocal)<<MULT_PRECISION; | |
|---|---|---|
| 93: | | |
| 94: | //-------------------------------------------------- | |
| 95: | // Determine difference from local average | |
| 96: | //------------------------------------------------- | |
| 97: | Y_diff = | Y-Y_ave; |
| 98: | Y_abs_diff = | (Y_diff < 0)? 0-Y_diff: Y_diff; |
| 99: | | |

| | |
|---|---|
| 100: | //-------------------------------------------------- |
| 101: | // Determine correction to be applied based |

| | |
|---|---|
| 102: | // on the difference |
| 103: | //------------------------------------------------- |

| | | |
|---|---|---|
| 104: | mask_scale = | (Y_diff < 0)? mask_scale_neg : |

mask_scalepos;

| | | |
|---|---|---|
| 105: | mask_thresh = | (Y_diff < 0)? mask_thresh_neg : |

mask_thresh_pos;

| | |
|---|---|
| 106: | Y_new = (Y +((mask_scale * Y_diff)>>MULT_PRECISION)); |
| 107: | Y_new = (Y +((mask_scale * Y_diff)>>MULT_PRECISION)); |
| 108: | Y_new = (Y_new < 0)? 0: Y_new; |
| 109: | Y_new CY_new > max_val)? max_val: Y_new; |
| 110: | /// change only if difference exceeds threshold |
| 111: | line_out[c] = (Y_abs_diff >= mask_thresh)? Y_new: Y; |

| | |
|---|---|
| 112: | } |
| 113: | line_in += pad_width; |
| 114: | line_out += pad_width; |

| 115: | | } |
|---|---|---|
| 116: | | |
| 117: | | break; |
| 118: | case 5: | |
| 119: | | for (r=0; r < height; r++) |
| 120: | | { |

| | |
|---|---|
| 121: | for (c=0; c < width; c++) |
| 122: | { |

| | |
|---|---|
| 123: | Y =line_in[c]; |
| 124: | |
| 125: | //------------------------------------------------------- |
| 126: | // Determine the average of the neighborhood |
| 127: | // start with a negative of the current pixel |
| 128: | // as it will be added later in the following loop |
| 129: | //------------------------------------------------------- |
| 130: | Y_ave =((I32) line_in[0-pad_width2+c-2])+ |

| | |
|---|---|
| 131: | ((I32) line_in[0-pad_width2+c-1])+ |
| I32: | ((I32) line_in[0-pad_width2+c])+ |
| 133: | ((I32) line_in[0-pad_width2+c+1])+ |
| 134: | ((I32) line_in[0-pad_width2+c+2])+ |
| 135: | ((I32) line_in[0-pad_width +c-2])+ |
| 136: | ((I32) line_in[0-pad_width +c-1])+ |
| 137: | ((I32) line_in[0-pad_width +c])+ |
| 138: | ((I32) line_in[0-pad_width +c+1])+ |
| 139: | ((I32) line_in[0-pad_width +c+2])+ |
| 140: | ((I32) line_in[c-2])+ |
| 141: | ((I32) line_in[c-1])+ |
| 142: | ((I32) line_in[c])+ |
| 143: | ((I32) line_in[c+1])+ |
| 144: | ((I32) line_in[c+2])+ |
| 145: | ((I32) line_in[pad_width +c-2])+ |
| 146: | ((I32) line_in[pad_width +c-1])+ |
| 147: | ((I32) line_in[pad_width +c])+ |
| 148: | ((I32) line_in[pad_width +c+1])+ |
| 149: | ((I32) line_in[pad_width +c-2])+ |
| 150: | ((I32) line_in[pad_width2+c-2])+ |
| 151: | ((I32) line_in[pad_width2+c-1])+ |
| 152: | ((I32) line_in[pad_width2+c])+ |
| 153: | ((I32) line_in[pad_width2+c+1]) + |
| 154: | ((I32) line_in[pad_width2+c+2]); |

| | |
|---|---|
| 155: | Y_ave = (Y_ave * nbhd_pixels_reciprocal)>>MULT_PRECISION; |
| 156: | |
| 157: | //-------------------------------------------------- |
| 158: | // Determine difference from local average |
| 159: | //------------------------------------------------- |
| 160: | Y_diff = Y-Y_ave; |
| 161: | Y_abs_diff = (Y_diff <[0 0)? 0-Y_diff: Y_diff; |
| 162: | //change only if difference exceeds threshold |
| 163: | |
| 164: | //-------------------------------------------------- |
| 165: | // Determine correction to be applied based |
| 166: | // on the difference |
| 167: | //------------------------------------------------- |
| 168: | mask_scale (Y_diff <[0 0)? mask_scale_neg |

mask_scale_pos;

| | |
|---|---|
| 169: | mask_thresh =(Y_diff <[0 0)? mask_thresh_neg |

mask_thresh.pos;

| | |
|---|---|
| 170: | Y_new = (Y +((mask_scale * Y_diff)>>MULT_PRECISION)); |
| 171: | Y_new = (Y + ((mask_scale * Y_diff)>>MULT_PRECISION)); |
| 172: | Y_new = (Y_new <[0 0)? 0: Y_new; |
| 173: | Y_new = (Y_new >max_val)? max_val: Y_new; |
| 174: | |
| 175: | line_out[c]= 2 (Y_abs_diff >= mask_thresh)? Y_new: Y; |

| | |
|---|---|
| 176: | } |
| 177: | line_in += pad_width; |
| 178: | line_out += pad width; |

| 179: | | } |
|---|---|---|
| 180: | | |
| 181: | | break; |
| 182: | default: | |
| 183: | | |
| 184: | | for (r=0; r < height; r++) |
| 185: | | { |

| | | |
|---|---|---|
| 186: | | for (c=0; c < width; c++) |
| 187: | { | |

| 188: | Y = line_in[c]; | |
|---|---|---|
| 189: | | |
| 190: | //------------------------------------------------------- | |
| 191: | // Determine the average of the neighborhood | |
| 192: | // | start with a negative of the current pixel |
| 193: | // | as it will be added later in the following loop |

| | |
|---|---|
| 194: | //------------------------------------------------------- |
| 195: | Y_ave=−1 * Y; |
| 196: | line_nbr = line_in - (nbhd_half_width * pad_width); |
| 197: | for (r_nbhd=−nbhd_half_width; r_nbhd <[0 = nbhd_half_width; |

r_nbhd++)

| | |
|---|---|
| 198: | { |

| | |
|---|---|
| 199: | for (c_nbhd =−nbhd_half_width; c_nbhd <= |

nbhd_half width; c_nbhd++)

| | |
|---|---|
| 200: | { |

| | |
|---|---|
| 201: | Y_ave += line nbr[c+c_nbhd]; |

| | |
|---|---|
| 202: | } |

| | |
|---|---|
| 203: | line_nbr += pad_width; |

| | |
|---|---|
| 204: | } |
| 205: | Y_ave =(Y_ave * nbhd_pixels_reciprocal)>>MULT_PRECISION; |
| 206: | |
| 207: | //-------------------------------------------------- |
| 208: | // Determine difference from local average |
| 209: | //------------------------------------------------- |
| 210: | Y_diff Y-Y_ave; |
| 211: | Y_abs_diff (Y_diff < 0)? 0-Y_diff: Y_diff; |
| 212: | //change only if difference exceeds threshold |
| 213: | |
| 214: | //-------------------------------------------------- |
| 215: | // Determine correction to be applied based |
| 216: | // on the difference |
| 217: | //------------------------------------------------- |
| 218: | mask_scale =(Y_diff < 0)? mask_scale_neg |

mask_scale_pos;

| | |
|---|---|
| 219: | mask_thresh = (Y_diff < 0)? mask_thresh_neg |

mask_thresh_pos;

| | |
|---|---|
| 220: | Y_new = (Y + ((mask_scale * Y_diff)>>MULT_PRECISION)); |
| 221: | Y_new (Y_new < 0)? 0: Y_new; |
| 222: | Y_new (Y_new > max_val)? max_val: Y_new; |
| 223: | |
| 224: | line_out [c] = (Y_abs_diff >= mask_thresh)? Y_new: Y; |

| | |
|---|---|
| 225: | } |
| 226: | line_in += pad_width; |
| 227: | line_out += pad_width; |

| | |
|---|---|
| 228: | } |

| | |
|---|---|
| 229: | } |
| 230: | |
| 231: | //----------------------------------------- |
| 232: | // Free up old Y channel |
| 233: | //----------------------------------------- |
| 234: | free(pad_Yarray); pad_Yarray = pad_Yout; |
| 235: | Yarray = pad_array + (pad * pad_width) + pad; |
| 236: | |
| 237: | |
| 238: | __LSURF_PROFILE_END; |
| 239: | |

| | |
|---|---|
| 240: | } |
| 241: | |
| 242: | |

3. Extracting Message Components

The currently-preferred embodiment extracts media-object attachments (i.e., attachments meeting user-specified criteria) from the body of the message for optimized processing and replacing with a URL; all other types of attachments (i.e., attachments that do not meet user-specified criteria) are left intact. The message analyzer saves all the data for the sender, recipient, body text, and attachment(s) in a data structure, which the preferred embodiment implements in the Perl programming language. The message analyzer passes this data structure to the attachment extractor, which is capable of tailoring media attachments. The attachment extractor looks at the type of the media object in each attachment, and if that type is supported by the system, then it is removed from the MIME structure of the Perl/MIME component.

In the currently-preferred embodiment, the following exemplary Perl code module demonstrates the extraction of the message components and uploading of the media object (for the specific example of a JPEG image file) extracted from the attachment.

| 1: | package MxMime | | |
|---|---|---|---|
| 2: | use Per1Mx | | |
| 3: | use MIME::Parser | | |
| 4: | use LS_UploadClient | | |
| 5: | use base qw(Per1Mx MIME) | | |
| 6: | | | |
| 7: | sub | | |
| 8: | new | | |
| 9: | { | | |
| 10: | | if (!$GLOBAL::TFN) | |
| 11: | | | { $GLOBAL::TFN = 0 ; } |
| 12: | | | |
| 13: | | print | STDERR “Creating new MxMime\n” |
| 14: | | bless | { |

| | | | |
|---|---|---|---|
| 15: | NAME | => | MxMime, |
| 16: | FLAGS | => | SMFI_CURR_ACTS, |

| | |
|---|---|
| 17: | # optional callbacks |

| | | | | |
|---|---|---|---|---|
| 18: | # | CONNECT | => | \&connect_callback, |

| | | | | |
|---|---|---|---|---|
| 19: | | HELO | => | \&helo_callback, |
| 20: | | ENVFROM | => | \&envfrom_callback, |
| 21: | | ENVRCPT | > | \&envrcpt_callback, |
| 22: | | HEADER | => | \&header_callback, |
| 23: | # | EOH | => | \&eoh_callback, |
| 24: | | BODY | => | \&body_callback, |
| 25: | | EOM | => | \&eom_callback, |
| 26: | | ABORT | => | \&abort_callback, |
| 27: | | CLOSE | => | \&close_callback |

| 28: | | }, shift |
|---|---|---|
| 29: | } | |
| 30: | | |
| 31: | | |
| 32: | # Called on recipt of HELO command | |
| 33: | sub | |
| 34: | helo_callback | |
| 35: | { | |
| 36: | | my ($ctx, $who) = @_ ; |
| 37: | | |
| 38: | | resetState($ctx) ; |
| 39: | | return SMFIS_CONTINUE ; |
| 40: | } | |
| 41: | | |
| 42: | # Called on recipt of MAIL FROM command | |
| 43: | sub | |
| 44: | envfrom_callback | |
| 45: | { | |
| 46: | | my ($ctx, @args) = @_ ; |
| 47: | | |
| 48: | | print STDERR “<< in envfrom_callback\n” ; |
| 49: | | resetState ($ctx) ; |
| 50: | | $ctx−>{‘env_from’} = $args[0] ; |
| 51: | | |
| 52: | | # Todo: Verify that the sender has a valid photo web account. |
| 53: | | if (!1) |

| | |
|---|---|
| 54: | { return SMFIS_REJECT ; } |

| | |
|---|---|
| 55: | else |

| | |
|---|---|
| 56: | { return SMFIS_CONTINUE ; } |

| 57: | } | |
|---|---|---|
| 58: | | |
| 59: | # Called on recipt of RCPT TO command. | |
| 60: | sub | |
| 61: | envrcpt_callback | |
| 62: | { | |
| 63: | | my ($ctx, @args) = @_ ; |
| 64: | | |
| 65: | | print STDERR “<< in envrcpt_callback\n” ; |
| 66: | | $ctx−>{‘env_rcpt’} = $args[0] ; |
| 67: | | return SMFIS_CONTINUE ; |
| 68: | } | |
| 69: | | |
| 70: | # Called for the mail headers. | |
| 71: | sub | |
| 72: | header_callback | |
| 73: | { | |
| 74: | | my ($ctx, $headername, $headerval) = @_ ; |
| 75: | | |
| 76: | | # print (“Inside header_callback:\n”) ; |
| 77: | | $ctx−>{‘data_headers}.= “$headername: $headerval\n”) ; |
| 78: | | ${$ctx−>{hash_headers }}−>{ = ($headername) } = $headerval ; |
| 79: | | # print (“Full headers:\n“) ; |
| 80: | | # print ($ctx−>{‘data_headers’}) ; |
| 81: | | |
| 82: | | return SMFIS_CONTINUE ; |
| 83: | } | |
| 84: | | |
| 85: | # Called for the message body. We store this for later work. | |
| 86: | sub | |
| 87: | body_callback | |
| 88: | { | |
| 89: | | my ($ctx, $bodyblock) = @_ ; |
| 90: | | |
| 91: | | $ctx−>{‘data_body’{ .= $bodyblock |
| 92: | | return SMFIS_CONTINUE ; |
| 93: | } | |
| 94: | | |
| 95: | # Here's where most of the work is done | |
| 96: | sub | |
| 97: | eom_callback | |
| 98: | { | |
| 99: | | my ($ctx) = shift ; |
| 100: | | my ($fullmsg, $parser, $rootentity, @parts, @recips) ; |
| 101: | | my $comp = 0 ; |
| 102: | | my $msg ; |
| 103: | | |
| 104: | | $parser = new MIME::Parser ; |
| 105: | | |
| 106: | | # DEBUGGING |
| 107: | | print STDERR “<< $$ - New Message\n” ; |
| 108: | | print STDERR “<< Length of \$fullmsg: ” . length($fullmsg) . “\n” ; |
| 109: | | |
| 110: | | # Assemble the full message for MIME::Parser |
| 111: | | $fullmsg = $ctx−>{‘data_headers’} |
| 112: | | $fullmsg .= “\n” ; |
| 113: | | $fullmsg .= $ctx−>{data_body’} ; |
| 114: | | |
| 115: | | # DEBUGGING |

| | |
|---|---|
| 116: | print STDERR “<< MID . ${$ctx−>{hash_headers }}.>{‘message- |

id′} . “\n” ;

| | |
|---|---|
| 117: | print STDERR “<< From: ” . ${$ctx−>{‘hash_headers’}}−>{‘fom’} . |

“\n” ;

| | |
|---|---|
| 118: | print STDERR “<< To : ” . ${$ctx−>{‘hash_headers’}}−>{‘to’} . “\n” ; |
| 119: | print STDERR “<< Subj: ” . ${ctx−>{‘hash_headers’}}−>{‘subject’} . |

“\n” ;

| | |
|---|---|
| 120: | print STDERR “<< Parser: $parser\n” ; |
| 121: | |
| 122: | # Extract the recipients. Send this to photo web site to enable |

sharing the image.

| | |
|---|---|
| 123: | @recips = parseAddrs ($ctx) ; |
| 124: | |
| 125: | # Staging area |
| 126: | $parser−>output_under ( “/tmp/stage”) ; |
| 127: | |
| 128: | # Parse the message into NINE entities |
| 129: | $rootentity $parser−>parse_data($fullmsg) ; |
| 130: | |
| 131: | # DEBUGGING |
| 132: | $len = length($rootentity−>stringify( )) ; |
| 133: | print STDERR “<< RootEntity: $rootentity\n” ; |
| 134: | print STDERR “<< Original Length: $len\n” ; |
| 135: | print STDERR “<< Number of Parts: ” . scalar($rootentity−>parts) . “\n” |
| 136: | |
| 137: | # DEBUGGING |
| 138: | my ($now, $file) ; |
| 139: | $now = time( ) ; |
| 140: | $file = “/tmp/stage/$$.$now” |
| 141: | open (DBG, “>$file”) ; |
| 142: | print DBG $rootentity−>stringify( ) ; |
| 143: | close DBG ; |
| 144: | print STDERR “<< Debug file: $file\n” ; |
| 145: | |
| 146: | @parts = $rootentity−>parts( ) ; |
| 147: | |
| 148: | if (scalar(@parts)) |
| 149: | { |

| | |
|---|---|
| 150: | my $part, $loc ; |
| 151: | $loc = 0 ; |
| 152: | |
| 153: | # Iterate over each entity, look for image/jpeg attachments |
| 154: | foreach $part (@parts) |
| 155: | { |

| | |
|---|---|
| 156: | if (lc($part−>head−>mimetype) eq “image/jpeg” \|\| lc($part- |

>head−>mimetype) eq “application/octet-stream”)

| | |
|---|---|
| 157: | { |

| 158: | # Found an image/jpeg | | |
|---|---|---|---|
| 159: | my $imgloc $part−>bodyhandle−>path ; | | |
| 160: | | | |
| 161: | # Connect to photo web site, abort if error. | | |
| 162: | my | $uc = | new LS_UploadClient |

(“http://myPhotoWebSite.com”, “10LG001000G00003J5537Y9M”) ;

| | |
|---|---|
| 163: | if (!defined($uc)) |
| 164: | { |

| | |
|---|---|
| 165: | warn (“new LS_UploadClient failed\n”) ; |
| 166: | next ; |

| | |
|---|---|
| 167: | { |
| 168: | |
| 169: | # Upload and share image |
| 170: | $photoid = $uc−>UploadImageCompartment (time( ) , |

“image/jpeg”, $imgloc, 1, 0, 0) ;

| | |
|---|---|
| 171: | if (defined($photoid)) |
| 172: | { |

| | |
|---|---|
| 173: | my $emailurl = $uc−> GetEmailUrl (“elementID”, |

$photoid, \@recips) ;

| | |
|---|---|
| 174: | print STDERR “<< Email URL: $emailurl\n” ; |
| 175: | if (defined($emailurl)) |
| 176: | { |

| | |
|---|---|
| 177: | # Remove the image from the message body |
| 178: | if Cref($emailurl) eq ARRAY) |
| 179: | { |

| | |
|---|---|
| 180: | print STDERR “<< Dereferencing |

\$emailurl\n” ;

| | |
|---|---|
| 181: | $emailurl = $$emailurl[0] ; |
| 182: | print STDERR “<< New emailurl: |

$emailurl\n” ;

| | |
|---|---|
| 183: | } |
| 184: | $rootentity−>parts ([grep {!/\Q$part\E/} |

$rootentity−>parts ] ) ;

| | |
|---|---|
| 185: | print STDERR “<< New Length: “ . |

length($rootentity−>stringify) . “\n” ;

186:

| | |
|---|---|
| 187: | # Add the URL to the signature. This |

gets appended later.

| | |
|---|---|
| 188: | $msg .= “View your photo: $emailurl\n” ; |
| 189: | |
| 190: | $part−>bodyhandle−>purge ( ) ; |
| 191: | $comp = 1 ; |

| | |
|---|---|
| 192: | } |

| | |
|---|---|
| 193: | } else { |

| | |
|---|---|
| 194: | warn (“No PhotoID\n”) ; |

| | |
|---|---|
| 195: | } |

| | |
|---|---|
| 196: | { |

| | | |
|---|---|---|
| 197: | | $loc++ ; |
| 198: | } | |

| | |
|---|---|
| 199: | } |
| 200: | |
| 201: | |
| 202: | if ($comp) |
| 203: | { |

| | |
|---|---|
| 204: | # Execute only if an attachment was shared |
| 205: | |
| 206: | # DEBUGGING |
| 207: | print STDERR “<< New Length: ” . length($rootentity−>stringify) |

“\n” ;

| | |
|---|---|
| 208: | print STDERR “<<Number of parts: ” . scalar ($rootentity−>parts) |

“\n” ;

| | |
|---|---|
| 209: | print STDERR “<<Upload successful.\n” ; |
| 210: | |
| 211: | my $now = time( ) ; |
| 212: | open (MSG, “>/tmp/$$.$now”) ; |
| 213: | print MSG “$msg” ; |
| 214: | close MSG ; |
| 215: | |
| 216: | # #Append the URL to the message |
| 217: | $rootentity−>sign(Filep32 >“/tmp/$$.$now”) ; |
| 218: | unlink (“/tmp/$$.now”) ; |
| 219: | my $newbody $rootentity−>stringify( ) ; |
| 220: | $ctx−>replacebody ($newbody) ; |
| 221: | |
| 222: | # Cleanup |
| 223: | $rootentity−>purge( ) ; |
| 224: | resetState ($ctx) ; |
| 225: | return SMFIS_CONTINUE ; |

| | |
|---|---|
| 226: | } else { |

| | |
|---|---|
| 227: | # No attachment was shared. |
| 228: | |
| 229: | print STDERR “<< No upload or upload failed.\n” |
| 230: | |
| 231: | # Cleanup |
| 232: | $rootentity−>purge( ) ; |
| 233: | resetState ($ctx) ; |
| 234: | return SMEIS_CONTINUE ; |

| 235: | | } |
|---|---|---|
| 236: | } | |
| 237: | | |
| 238: | | |
| 239: | # Called on abort | |
| 240: | sub | |
| 241: | abort_callback | |
| 242: | { | |
| 243: | | my ($ctx) = @_ ; |
| 244: | | |
| 245: | | resetState ($ctx) ; |
| 246: | | return SMEIS_CONTINUE ; |
| 247: | } | |
| 248: | | |
| 249: | # Called at the end of the session | |
| 250: | sub | |
| 251: | close_callback | |
| 252: | { | |
| 253: | | my ($ctx) = @_ ; |
| 254: | | |
| 255: | | resetState ($ctx) |
| 256: | | |
| 257: | | return SMFIS_CONTINUE |
| 258: | } | |
| 259: | | |
| 260: | # Clean up the message context | |
| 261: | sub | |
| 262: | resetState | |
| 263: | { | |
| 264: | | my ($ctx) = @_ ; |
| 265: | | |
| 266: | | $ctx−>{‘data_body’} = undef ; |
| 267: | | $ctx−>{‘data_headers’} = undef ; |
| 268: | | $ctx−>{‘env_from’} = undef ; |
| 269: | | $ctx−>{‘env_rcpt’} = undef ; |
| 270: | | $ctx−>{‘hash_headers’} = undef ; |
| 271: | | |
| 272: | | print STDERR “<< ResetState\n” |
| 273: | | |
| 274: | | return |
| 275: | } | |
| 276: | | |
| 277: | # Parse addresses and return a list of them | |
| 278: | sub | |
| 279: | parseAddrs | |
| 280: | { | |
| 281: | | my ($ctx) = @_ ; |
| 282: | | my ($to, $cc) |
| 283: | | my (@ato, @acc, %rh, @r, $addr) |
| 284: | | |
| 285: | | $to = ${$ctx−>{‘hash_headers’}}−>{‘to’} ; |
| 286: | | @ato = split(/\s+/, $to) |
| 287: | | |
| 288: | | $cc = ${$ctx−>{‘hash_headers’}}−>{‘cc’} ; |
| 289: | | @acc = split(/\s+/, $cc) ; |
| 290: | | |
| 291: | | foreach $addr (@acc) |
| 292: | | { |

| | |
|---|---|
| 293: | next unless ($addr =˜ /\w+\@\w+\.\w+/) ; |
| 294: | $addr =˜ s/,// ; |
| 295: | $rh{$addr}= 1 ; |

| | |
|---|---|
| 296: | } |
| 297: | |
| 298: | foreach $addr (@ato) |
| 299: | { |

| | |
|---|---|
| 300: | next unless ($addr =˜ /\w+\@\w+\.\w+/) ; |
| 301: | $addr =˜ s/,// ; |
| 302: | $rh{$addr}= 1 |

| | |
|---|---|
| 303: | } |
| 304: | |
| 305: | @r = keys (%rh) ; |
| 306: | |
| 307: | my ($r) ; |
| 308: | foreach $r (@r) |
| 309: | { |

| | |
|---|---|
| 310: | print “Recip: $r\n” ; |

| | |
|---|---|
| 311: | } |
| 312: | |
| 313: | return @r ; |

| | |
|---|---|
| 314: | } |
| 315: | |
| 316: | return 1 |
| 317: | |
| 318: | # Vi: set ts=2: |

Of particular interest are the following operations. At line 123, the list of recipients is parsed from the header information and stored in an array, recips. At line 129, an object, rootentity, is created which holds the entire message: this consists of all 50 of the components of the body in the message parsed into separate nodes (body text and attachments). The root node is rootentity, and this tree is persisted to disk storage. At line 146, a list of the parts, named parts, of the body of the message is created. At line 154, parts is iterated over for operations up through line 196. At line 156, each node is tested to determine if it is an attachment of interest—a JPEG image (for this example). If the part is a valid JPEG image, at line 159, the path, path, of its location on disk is captured, and, at line 162, the process makes an Internet connection to a corresponding photo Web site (or other suitable repository) to upload this image.

At line 170, the JPEG image is uploaded, accompanied by a unique ID (a UNIX long integer time stamp), to the photo Web site, where a “share” event/operation (i.e., specifying that the image is to be shared among multiple users) is created for it. A share is associated with a unique on-line photo ID. If the upload operation is successful, at line 173, a URL object corresponding to the photo ID is returned to the multimedia message extractor. At line 184, this part, or node, is removed from the rootentity object. At line 188, the URL for this JPEG image at the photo Web site is appended to a scalar label, “View your photo:”; these will later be appended to the body text of the new reconstituted e-mail that is sent to the recipient. The JPEG image may be removed from the local disk, if desired. At line 217, the composite scalar label and URL are appended to the body text of the original message, along with any non-JPEG attachments that were part of the original message. Finally, at line 220, the Sendmail Milter is called upon to replace the original body of the message with the newly refashioned one.

4. Summary of Overall Operations

In the currently-preferred embodiment, two high-level processes operate:

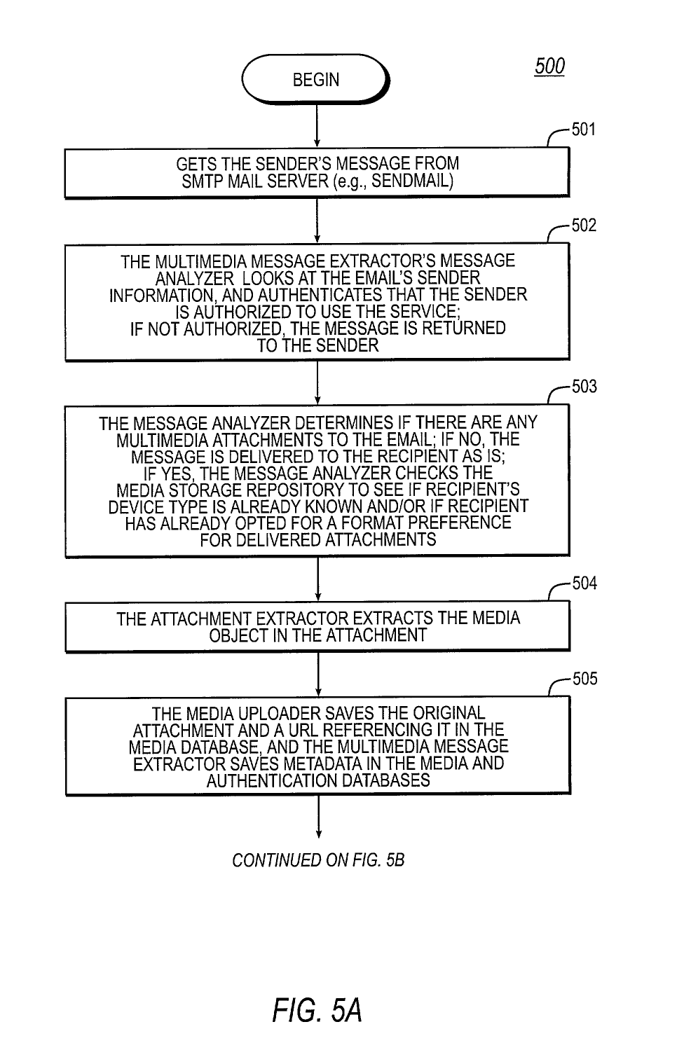

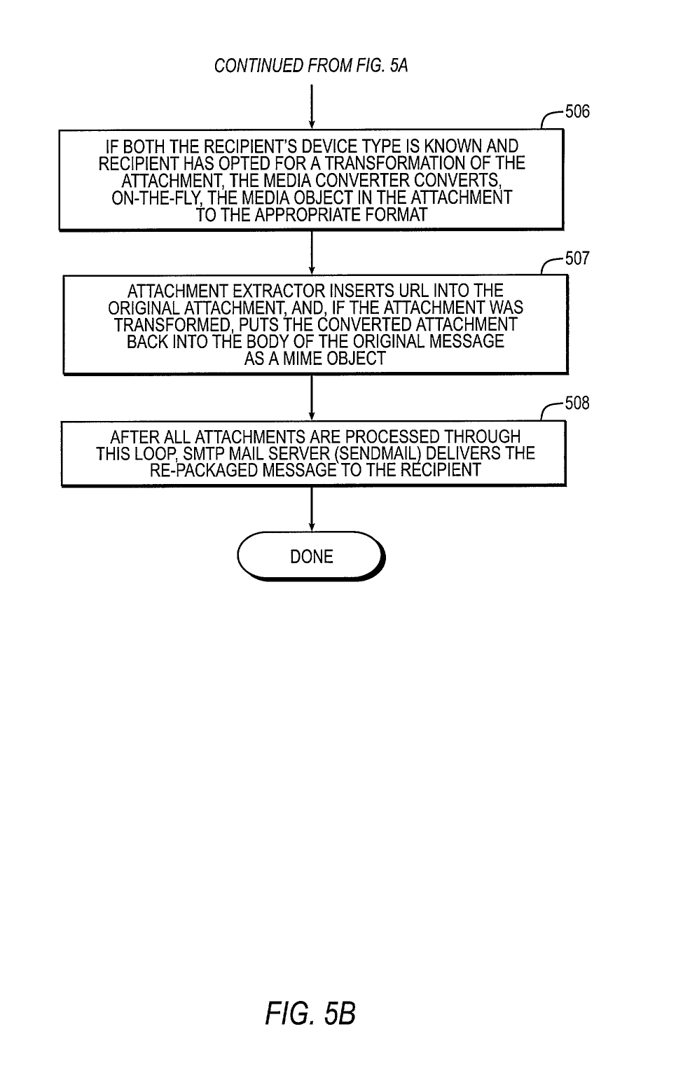

sending e-mail (with attachments) and receiving e-mail attachments via the link (URL). FIGS. 5A-B represent a high-level method 500 comprising the sequential steps in the process of sending potentially re-packaged e-mail. At step 501, the method operates to fetch the sender's message from the SMTP mail server (e.g., Sendmail). At step 502, the message analyzer (as previously shown at 410 in FIG. 4) in the multimedia message extractor identifies the message sender (from the e-mail header), and authenticates that the sender, or message originator, is authorized to use the service. If the sender is unknown, and therefore not authorized, the message is returned directly to the sender. At step 503, the message analyzer determines if there are any attachments to be extracted (e.g., multimedia attachments) from the e-mail message. If there are no multimedia attachments, the entire message is delivered to the recipient as is. If there are any attachments to be extracted, the message analyzer checks the media storage repository to determine whether the recipient's device type is already known and/or if this recipient has already opted for a format preference for delivered attachments.

At step 504, the message analyzer parses the message into MIME objects, and determines if the content type and sub-type of the MJME object(s) comprising an attachment are targeted types for re-processing (e.g., JPEG images are a content type “image,” and a content sub-type “jpeg”; specified in the MIME header as “image/jpeg” or “application/octet-stream”); if they are not, then the processing breaks from this loop to proceed to the next attachment. At step 505, the attachment validator determines if the object consists of a valid format for its content type/sub-type; if it does, the message extractor extracts the attachment from the original message; if not, then the processing breaks from this loop to proceed to the next attachment. At step 506, the media uploader connects to the target HTTP media delivery server, and uploads the object along with a URL referencing the location of that object which is stored in a network-sharing media storage repository. At step 507, the attachment extractor inserts the link (URL) into the original attachment, and, if the attachment was reformatted/transformed, the attachment extractor inserts the converted attachment back into the body of the original message as a MIME object. After all of the attachments are processed through this loop, at step 508 the SMTP mail server delivers the re-packaged message to the recipient.

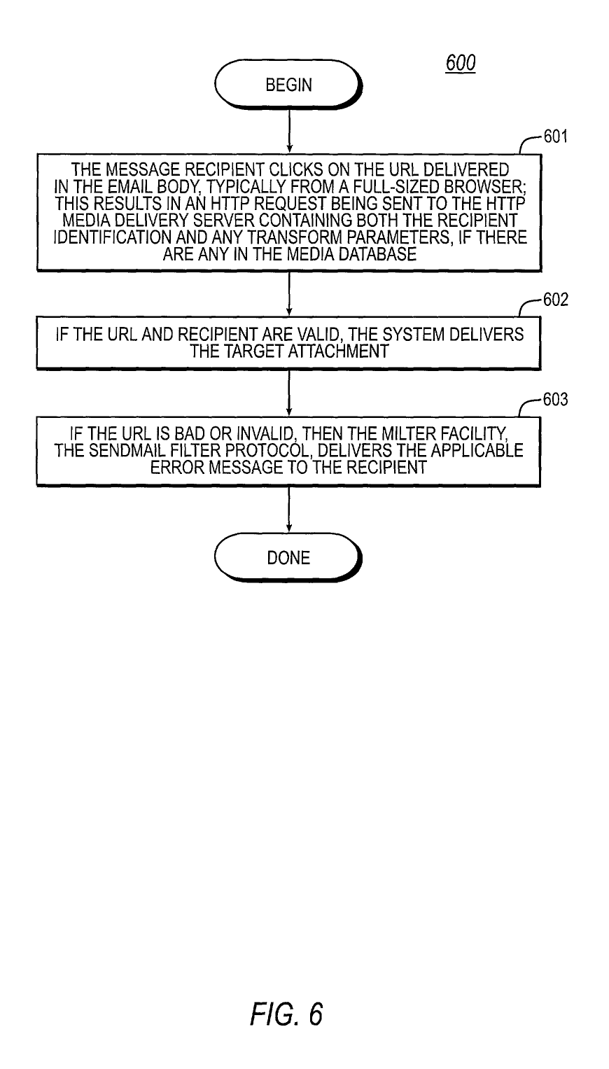

FIG. 6 represents a high-level method 600 comprising the sequential steps in the process of receiving e-mail from the present invention via the link (URL). At step 601, the message recipient clicks on the link delivered in the e-mail body, typically from a Web-enabled the mail client software (e.g., Microsoft Outlook with Internet Explorer). This invocation results in an HTTP request being sent to the HTTP media delivery server; the request contains both the recipient identification and any transform parameters (if any) in the media database. At step 602, if the invoked link and recipient are valid, the system delivers the target attachment. At step 603, if the link is bad or invalid, the Milter facility, the Sendmail filter protocol, delivers an applicable error message to the recipient. Typical of e-mail activity, the recipient may forward the message, with the URL attached, to several other “new” recipients. They, in turn, when accessing the attachment by clicking on the URL they received, proceed to register their client device types and opt for format preferences, if this is their first time using the system.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. In an online messaging system supporting transmission of attachments, a method for automatically processing messages containing attachments, the method comprising:
specifying a preference for formatting attachments that accompany messages;
receiving a particular message having a particular attachment;
removing the particular attachment from the particular message;
inserting a link into the particular message, said link capable of referencing the particular attachment that has been removed;
delivering the particular message to an intended recipient; and
in response to invocation of the link by the intended recipient, retrieving a copy of the particular attachment that is automatically formatted based on the specified preference.

2. The method of claim 1, wherein the preference is associated with a particular user.

3. The method of claim 1, wherein the preference is associated with a particular device of a user.

4. The method of claim 1, wherein said online messaging system comprises an e-mail messaging system.

5. The method of claim 1, wherein said attachment includes media objects.

6. The method of claim 5, wherein said media objects comprise selected ones of audio content, video content, images, and documents.

7. The method of claim 1, wherein said preference includes specifying that attachments which comprise images be formatted to a particular resolution.

8. The method of claim 1, wherein said preference includes specifying that attachments which comprise images be transformed from one file format to another.

9. The method of claim 1, wherein said step of receiving a particular message includes:
receiving the particular message at an SMTP server.

10. The method of claim 9, wherein said step of removing the particular attachment occurs at said SMTP server.

11. The method of claim 9, wherein said step of removing the particular attachment occurs after processing by the SMTP server.

12. The method of claim 1, wherein said particular message includes a MIME attachment.

13. The method of claim 12, wherein said MIME attachment includes media objects.

14. The method of claim 12, wherein said MIME attachment includes digital images.

15. The method of claim 1, wherein said link comprises a Uniform Resource Locator (URL) referencing said attachment that has been removed.

16. The method of claim 1, wherein the copy of the particular attachment is automatically formatted when a request is received to retrieve the particular attachment.

17. The method of claim 1, wherein the copy of the particular attachment is automatically formatted when the particular attachment is removed from the particular message.

18. The method of claim 1, wherein copies of attachments that are removed are stored in a network repository.

19. The method of claim 1, wherein said formatting includes converting objects within an attachment from one format to another type of format.

20. The method of claim 1, wherein said formatting includes decreasing the size of objects within an attachment.

21. The method of claim 20, wherein said decreasing the size of objects includes transforming the objects to a lower resolution.

22. The method of claim 21, wherein said decreasing the size of objects includes transforming the objects from color to monochromatic.

23. The method of claim 1, wherein formatted copies of objects within the particular attachment are stored in a network repository.

24. The method of claim 23, wherein said network repository is accessible by a Web browser for shared access among multiple participants.

25. The method of claim 1, wherein said particular attachment includes JPEG-formatted digital images.

26. In an online system, a method for providing digital images to target devices, the method comprising:
receiving a message having one or more attached objects;
detaching said objects from said message;
automatically transforming copies of said objects to a resolution fidelity that is more useful to said target devices;
for each detached object, generating a reference allowing retrieval of a transformed copy of the detached object; and
delivering the message to the target devices, the message including said generated reference for each detached object.

27. The method of claim 26, wherein said transforming step includes converting copies of said objects to another type of format.

28. The method of claim 26, wherein said transforming step includes decreasing the size of the copies of said objects.

29. The method of claim 28, wherein the step of decreasing the size of said objects includes transforming the objects to a lower fidelity.

30. The method of claim 26, wherein transformed copies of said objects are stored in a network repository.

31. The method of claim 26, wherein said objects comprise digital images.

32. The method of claim 31, wherein said digital images are stored in JPEG format.

33. The method of claim 26, wherein said reference includes a Uniform Resource Locator (URL) for referencing a transformed copy of a detached object.

34. In an online system, a method for providing a particular target device with a digital image optimally formatted for that particular target device:
specifying a device type for the particular target device;
based on the specified device type, determining device capabilities for the particular target device;
before delivery of digital images to the particular target device, automatically transforming said digital images to an optimal format for the particular target device; and
delivering said transformed digital images to the particular target device.

35. The method of claim 34, wherein said step of specifying a device type includes:
allowing user specification of a device type for the particular target device.

36. The method of claim 35, further comprising:
providing a Web browser interface allowing user specification of a device type for the particular target device.

37. The method of claim 34, wherein said step of specifying a device type includes:
querying the particular target device for determining its device type.

38. The method of claim 34, wherein said device capabilities include communication bandwidth available to the particular target device.

39. The method of claim 34, wherein said device capabilities include display capabilities available to the particular target device.

40. The method of claim 34, wherein said optimal format includes an optimal image size.

41. The method of claim 34, wherein said optimal format includes an optimal image resolution.

42. The method of claim 34, wherein said optimal format includes an optimal image file format for the particular target device.

43. The method of claim 34, further comprising:
allowing a given user to specify a plurality of target devices.

44. The method of claim 43, wherein said determining device capabilities includes:
determining a least common denominator among the plurality of target devices specified by the user.

45. The method of claim 43, wherein said least common denominator comprises an image file format that is compatible with the plurality of target devices specified by the user.

46. An e-mail system for providing e-mail having attachments, the system comprising:
an e-mail server for receiving a particular e-mail message having an attachment, the particular e-mail message being addressed to a recipient having a target device capable of receiving e-mail, the attachment including one or more objects;
an attachment processing module for replacing the attachment with at least one reference;
a transformation module for transforming the objects of the attachment to a desired format, based on capabilities of the target device; and
a retrieval module allowing retrieval of the transformed objects, in response to invocation of at least one reference.

47. The system of claim 46, wherein the attachment of the particular e-mail message comprises a MIME attachment.

48. The system of claim 47, wherein the MIME attachment includes one or more digital images.

49. The system of claim 46, wherein said e-mail server comprises an SMTP server.

50. The system of claim 46, wherein said attachment processing module operates as a plug-in module to said e-mail server.

51. In an online messaging system supporting transmission of attachments, a method for automatically processing messages containing attachments, the method comprising:
specifying a preference for formatting attachments that accompany messages;
receiving a particular message having a particular attachment;
removing the particular attachment from the particular message;
inserting a copy of the particular attachment that is automatically formatted based on the specified preference; and
delivering the particular message to an intended recipient.
